(19) United States
(12) Patent Application Publication
(10) Pub. No.: US 2006/0172741 A1
(43) Pub. Date: Aug. 3, 2006

(54) Method and system for relocating serving radio network controller in a network sharing system

(75) Inventors: Kyeong-In Jeong, Suwon-Si (KR); Gert Jan Van Lieshout, Staines (GB)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/297,640

(22) Filed: Dec. 9, 2005

(30) Foreign Application Priority Data
Dec. 9, 2004 (KR) 2004-103305
Dec. 17, 2004 (KR) 2004-108275

(51) Int. Cl. H04Q 7/20

(52) U.S. Cl. 455/446; 455/449; 455/560

(57) ABSTRACT

A method and system for relocating a SRNC in a RAN in an NS system where the RAN is shared among a plurality of CN operators are provided. If an SRNC relocation from a source RNC to a target RNC is determined for a UE, the source RNC requests to the target RNC a PLMN list with the PLMN ids of CN operators sharing the target RNC, and receives the PLMN list from the target RNC, and provides the PLMN ID list to the UE. Upon receipt of a selected PLMN id from the UE, the source SRNC performs the SRNC relocation by selecting a CN operator corresponding to the selected PLMN id.

### PRIORITY

This application claims priority under 35 U.S.C. § 119(a) to an application entitled “Method and System for Relocating Serving Radio Network Controller in a Network Sharing System” filed in the Korean Intellectual Property Office on Dec. 9, 2004 and assigned Serial No. 2004-103305, and to an application entitled “Method and System for Relocating Serving Radio Network Controller in a Network Sharing System” filed in the Korean Intellectual Property Office on Dec. 17, 2004 and assigned Serial No. 2004-108275, the entire disclosures of which are hereby incorporated by reference.

### BACKGROUND OF THE INVENTION

1. Field of the Invention

The present invention relates generally to a Network Sharing (NS) system. More particular, the present invention relates to a method and apparatus for relocating a Serving Radio Network Controller (SRNC) in the NS system.

2. Description of the Related Art

A mobile communication system includes a Radio Access Network (RAN) and User Equipment (UE). The RAN has a Node B and is connected to a second network through a Core Network (CN). RANs, which are operated by different operators or use different radio access techniques, can be connected to a plurality of CNs operated by the same or different CN operators. The concept of sharing a RAN among different CN operators is called network sharing.

In a Code Division Multiple Access (CDMA) cellular mobile communication system, a RAN includes a Base Transceiver Subsystem (BTS) and a Base Station Controller (BSC). The RAN is connected to a CN with a Mobile Switching Center (MSC). Meanwhile, in a Global System for Mobile communications (GSM)-based Wideband CDMA (WCDMA) system called Universal Mobile Telecommunications System (UMTS), a RAN includes a Node B and a Radio Network Controller (RNC) and is connected to a CN with a Serving General Packet Radio Service (GPRS) Support Node (SGSN) and a Gateway GPRS Support Node (GGSN).

CN operators are identified by Public Land Mobile Network (PLMN) Identifiers (ids). A PLMN id is a combination of a Mobile Country Code (MCC) and a Mobile Network Code (MNC). A UE selects a PLMN id identifying a desired CN operator for itself or under the control of the network. To access the selected CN, the UE notifies a RAN, preferably an RNC in which the UE is connected, of the PLMN id.

In the UMTS system, an RNC in which the UE has established an initial RRC connection is called a SRNC. As the UE moves to a cell covered by another RNC, the UE connects the SRNC via the new RNC. The new RNC is called a Drift RNC (DRNC). The SRNC provides comprehensive control for the UE, including control of radio resources and access to a UE-selected CN. The SRNC identifies the UE-selected CN by a PLMN id to route the UE's access to the CN. The DRNC relays messages between the SRNC and the UE without any authority to control the UE.

A SRNC relocation is the process of moving an Access Point (AP) connecting a RAN to a CN from a source RNC to a target RNC. If a SRNC relocation is executed, the source RNC loses the authority to control the UE and the target RNC becomes a new SRNC. The SRNC relocation is confined to a UE in a Packet Mobility Management (PMM)-CONNECTED state with an lur interface that interfaces control signaling and user data. If the SRNC relocation takes place in an SGSN, which implies that the target RNC and the source RNC are under the control of the same SGSN, the relocation is an intra-SGSN SRNC relocation. Otherwise, an inter-SGSN SRNC relocation is performed.

When the SRNC relocation occurs in the NS system, PLMN ids broadcasted from the target RNC may include PLMN ids other than a UE-selected PLMN id from the source RNC. Also, the PLMN ids may have a PLMN id with a higher priority level than the UE-selected PLMN id. Conventionally, once a connection is established between the target RNC and a CN operator selected by the UE in the source RNC, the UE cannot connect to a CN operator with a higher priority level in the target RNC.

Accordingly, there is a need for an improved method and apparatus for connecting the UE to a CN operator after relocating a SRNC in a NS system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and system for requesting a target RNC to inform PLMN ids broadcasted from a target cell, before a SRNC relocation in a source RNC.

The present invention also provides a method and system for performing a SRNC relocation to a target CN operator by transmitting to a UE PLMN ids received from a target RNC and receiving a selected PLMN id from the UE in a source RNC.

The above objects are achieved by providing a method and system for relocating a SRNC in a RAN in an NS system where the RAN is shared among a plurality of CN operators.

According to one aspect of an exemplary embodiment of the present invention, in a SRNC relocation method in a RAN that controls radio resources for a UE in an NS system where the RAN is shared among a plurality of core network CN operators, a source RNC requests to a target RNC a CN operator ID list with IDs of CN operators sharing the target RNC, if a SRNC relocation from the source RNC to the target RNC is determined. The source RNC receives the CN operator ID list from the target RNC and provides the CN operator ID list to the UE. The source RNC then receives from the UE a CN operator ID selected from the CN operator ID list, selects a CN operator corresponding to the selected CN operator ID, and performs a SRNC relocation.

According to another aspect of an exemplary embodiment of the present invention, in a SRNC relocation method in a RAN that controls radio resources for a UE in an NS system where the RAN is shared among a plurality of core network CN operators, the UE receives from a source RNC a CN operator ID list with IDs of CN operators sharing a target RNC, if a SRNC relocation from the source RNC to the target RNC is determined. The UE selects an intended CN operator ID among the CN operators IDs and transmits the selected CN operator ID to the source RNC.

According to a further aspect of an exemplary embodiment of the present invention, in a SRNC relocation system of a RAN in an NS system where the RAN is shared among a plurality of CN, if a SRNC relocation from the source RNC to the target RNC is determined for a UE, a source RNC requests to a target RNC a CN operator ID list with IDs of CN operators sharing the target RNC, receives the CN operator ID list from the target RNC, and provides the CN operator ID list to the UE. The UE selects an intended CN operator ID among the CN operators IDs of the CN operator list and transmits the selected CN operator ID to the source RNC. Upon receipt of the selected CN operator ID from the UE, the source RNC performs the SRNC relocation by selecting a CN operator corresponding to the selected CN operator ID.

Other objects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other objects, features and advantages of certain exemplary embodiments of the present invention will become more apparent from the following description taken in conjunction with the accompanying drawings in which:

FIG. 1 illustrates the configuration of an NS system where different CN operators share a RAN;

FIG. 2 is a diagram illustrating a signal flow for an exemplary SRNC relocation applicable to an exemplary embodiment of the present invention;

FIG. 3 is a diagram illustrating a signal flow for a SRNC relocation according to an exemplary embodiment of the present invention;

FIG. 4 is a flowchart illustrating an operation of a source RNC according to an exemplary embodiment of the present invention; and

FIG. 5 is a flowchart illustrating an operation of a UE according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modification of the embodiments described herein can be made without departing from the scope and spirit of the invention. Also, descriptions of well-known functions and constructions are omitted for clarity and conciseness.

The subject matter of exemplary embodiments of the present invention pertains to a SRNC relocation in a NS system where a RAN is shared among different CN operators. After a PLMN id is selected by a UE in a target RNC, a source RNC executes the SRNC relocation to a CN operator corresponding to the PLMN id. With the SRNC relocation, the target RNC connects the UE to the selected CN operator.

In the NS system, CN operators sharing the target RNC may be different from those sharing the source RNC. When the source RNC decides to execute a SRNC relocation, the source RNC provides the UE with a PLMN list containing PLMN ids broadcasted from a target cell covered by the target RNC on a dedicated channel. The UE selects one of the PLMN ids and reports the selected PLMN id to the source RNC. The source RNC then determines a CN operator to connect to the UE in the target cell.

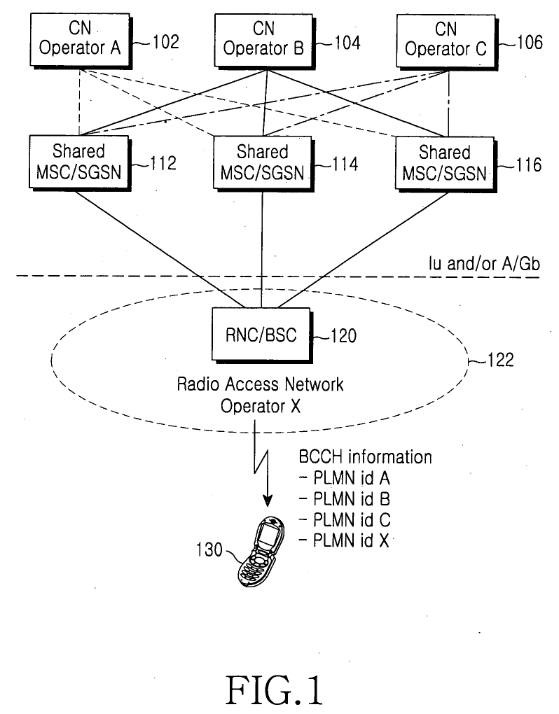

FIG. 1 illustrates the configuration of the NS system where different CN operators share a RAN. While the network configuration is based on 3rd generation (3G) asynchronous mobile communication standards set by 3rd Generation Partnership Project (3GPP), the exemplary embodiments of the present invention is not limited to the 3G standards. However, the exemplary embodiments of the present invention are applicable to any technology fields based on a concept of network sharing.

Referring to FIG. 1, a RAN 120, of which the service coverage is a cell 122, includes a RNC or BSC. The RAN 120 is connected to CN nodes 112, 114 and 116 via an Iu interface and/or an A/Gb interface. Each of the CN nodes 112, 114 and 116 includes a SGSN or MSC. While not illustrated in FIG. 1, the CN node further includes a GGSN according to the 3GPP standards.

Different CN operators 102, 104 and 106 (CN operators A, B and C, respectively) share the MSCs/SGSNs 112, 114 and 116. The RAN 120 belongs to a CN operator X and is also shared among the CN operators 102, 104 and 106. The RAN 120 provides a UE 130 with a PLMN list listing the PLMN ids of the CN operator X and the CN operators 102, 104 and 106, by transmitting system information on a Broadcast Control CHannel (BCCH) established in the cell 122. The UE 130 selects one of the PLMN ids in an Access Stratum (AS) layer or a Non Access Stratum (NAS) layer. The AS layer is responsible for protocols associated with a Uu interface between the RNC and the UE. The NAS layer overlies the AS layer, taking charge of protocols associated with the interface between the UE and a CN.

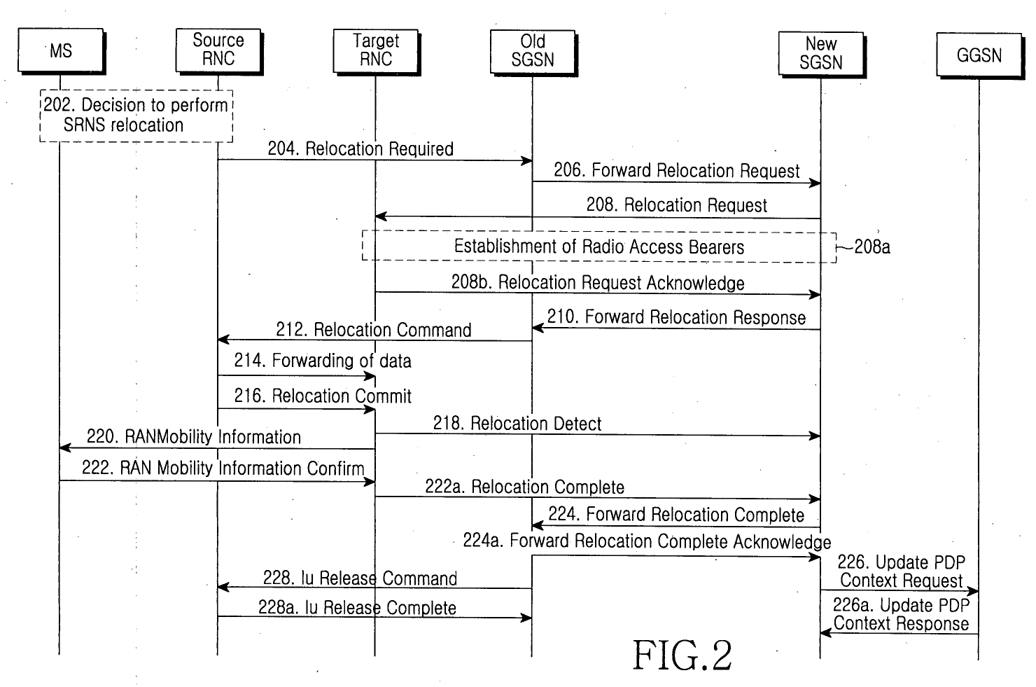

FIG. 2 is a diagram illustrating a signal flow for a SRNC relocation applicable to an exemplary embodiment of the present invention. The SRNC relocation signal flow varies depending on the SRNC relocation circumstances. In FIG. 2, a typical SRNC relocation is shown, which can be carried out commonly for an intra-SGSN SRNC relocation and an inter-SGSN SRNC relocation. The term “a source RNC” used herein refers to an old SRNC before a SRNC relocation and “a target RNC” refers to an RNC covering a target cell to which the UE moves to. A SGSN connected to the source RNC is called an old SGSN and a SGSN connected to the target RNC is called a new SGSN. In the case of an intra-SGSN SRNC relocation, the old SGSN and new SGSN are identical. Therefore, a signal flow between the old SGSN and the new SGSN is not required. Both the old and new SGSNs are connected to a second network via a GGSN.

Referring to FIG. 2, the source RNC decides to execute a SRNC relocation in step 202 and transmits a Relocation Required message to the old SGSN in step 204. The Relocation Required message is delivered to request the SRNC relocation to the old SGSN and contains a target RNC id and information about the UE (or Mobile Station (MS)) for which the SRNC relocation is performed. The old SGSN determines whether the target RNC is under its control by checking the target RNC id. If the target RNC is under the control of the new SGSN, the old SGSN transmits a Forward Relocation Request message to the new SGSN, and a resource allocation procedure for the SRNC relocation begins in step 206. The Forward Relocation Request message includes an International Mobile Station Identifier (IMSI) of the UE, a signaling end point id, a Mobility Management (MM) context, a Packet Data Protocol (PDP) context, and the target RNC id. The new SGSN transmits a Relocation Request message to the target RNC in response to the Forward Relocation Request message in step 208. The Relocation Request message includes a UE id, CN domain id, and Radio Access Bearers (RAB) information. The RAB is then established between the new SGSN and the target RNC in step 208a. The target RNC then transmits a Relocation Request Acknowledge message to the new SGSN in step 208b.

In step 210, the new SGSN transmits to the old SGSN a Forward Relocation Response message to notifying the old SGSN that resources have been established for user data transmission between the new SGSN, and the target RNC and the new SGSN is ready to perform the SRNC relocation. The Forward Relocation Response message, including the RAB information, indicates that the target RNC is prepared to receive downlink data forwarded by the source RNC. The old SGSN instructs the source RNC to forward data to the target RNC by transmitting a Relocation Command in step 212. The data is then forwarded in step 214. In step 216, the source RNC transmits to the target RNC a SRNC context containing information required to control the radio resources of the UE by a Relocation Commit message, thereby handing over the role of the SRNC to the target RNC.

Upon receipt of the Relocation Commit message, the target RNC notifies the new SGSN that the SRNC relocation has taken place by a Relocation Detect message in step 218. In step 220, the target RNC notifies the UE of a new SRNC id (that is, the target RNC id) and a Serving Radio Network Temporary Identifier (SRNTI) by a RAN Mobility Information message. As a result, the UE can transmit uplink user data to the target RNC. The UE completes a channel reconfiguration based on the information included in the RAN Mobility Information message, and transmits a RAN Mobility Information Confirm message to the target RNC in step 222. In step 222a, the target RNC notifies the new SGSN of completion of the SRNC relocation by a Relocation Complete message, upon receipt of the RAN Mobility Information Confirm message.

The new SGSN notifies the old SGSN of the SRNC relocation completion by a Forward Relocation Complete message in step 224 and receives a Forward Relocation Complete Acknowledge message from the old SGSN in step 224a. In step 228, the old SGSN instructs the source RNC to release the In interface by an Iu Release Command message. The old SGSN then receives an Iu Release Complete message from the source RNC in step 228a. Subsequently, the new SGSN switches a user plane from the source RNC to the target RNC and transmits to the GGSN an Update PDP Context Request message. The Update PDP Context message requests an update on the PDP context in step 226 and receives an Update PDP Context Response message from the GGSN in step 226a.

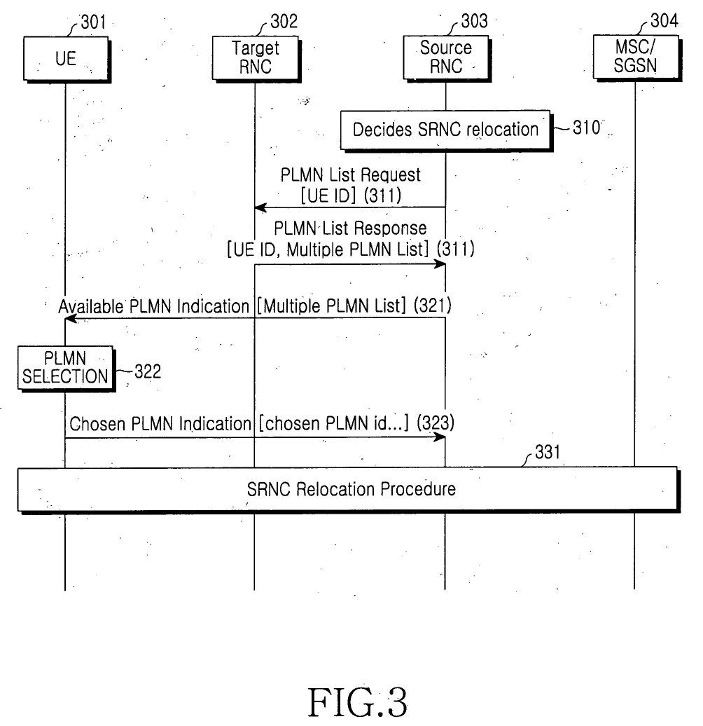

FIG. 3 is a diagram illustrating a signal flow for a SRNC relocation according to an exemplary embodiment of the present invention. Reference numeral 301 denotes a UE for which the SRNC relocation is carried out. Reference numerals 302 and 303 denote a target RNC and a source RNC, respectively. Reference numeral 304 denotes an MSC/SGSN involved in the SRNC relocation. Step 310 corresponds to step 202 of FIG. 2 and step 331 corresponds to a subsequent procedure starting with step 204 of FIG. 2.

Referring to FIG. 3, the source RNC 303 decides to execute a SRNC relocation in step 303 and requests PLMN ids broadcasted from a target cell where the UE 301 is located by transmitting a PLMN List Request message to the target RNC 302 in step 311. The PLMN List Request message may contain the ID of the UE 301.

If all cells under the control of an RNC are shared among the same CN operators and broadcast the same PLMN list in the NS system, the UE ID cannot be included in the PLMN List Request message. However, if each of the cells is shared among different CN operators and broadcasts a different PLMN list, the target RNC 302 determines the target cell of the UE 301 by the UE ID and acquires the PLMN list broadcasted from the target cell.

In step 312, the target RNC 302 transmits to the source RNC 303 a PLMN List Response message including the UE ID and a PLMN list with PLMN ids broadcasted from the target cell in which the UE 301 intends to move to. The PLMN List Request and PLMN List Response messages are transmitted via the lur interface between the RNCs 302 and 303.

In step 321, the source RNC 303 notifies the UE 301 of the PLMN list by transmitting an Available PLMN Indication message on a DCCH via the Uu interface, so that the UE 301 can select a desired PLMN id.

The UE 301 selects one of the PLMN ids of the PLMN list in step 322 and notifies the source RNC 303 of the selected PLMN id by a Chosen PLMN Indication message on a DCCH in step 323. The source RNC 303 selects a CN operator for the UE 301 based on the selected PLMN id in the SRNC relocation in step 331.

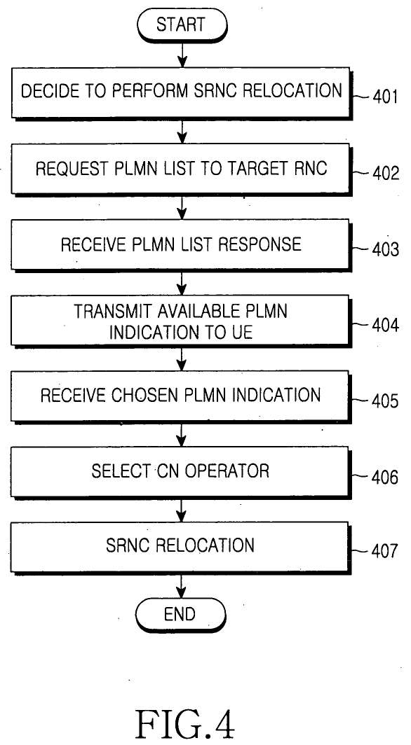

FIG. 4 is a flowchart illustrating an operation of the source RNC according to an exemplary embodiment of the present invention.

Referring to FIG. 4, the source RNC decides to execute a SRNC relocation in step 401 and transmits a PLMN List Request message to the target RNC, requesting PLMN ids broadcasted from the target cell covered by the target RNC in step 402. The PLMN List Request message includes a UE ID. In step 403, the source RNC receives from the target RNC a PLMN List Response message including the UE ID and PLMN list with the PLMN ids.

The source RNC transmits an Available PLMN Indication message with the PLMN ids to the UE on a DCCH in step 404. The source RNC also receives a Chosen PLMN Indication message with a UE-selected PLMN id from the UE in step 405. The source RNC selects a CN operator for the UE according to the PLMN id in step 406 and performs the SRNC relocation procedure in step 407.

Upon receipt of the PLMN List Request message, the target RNC transmits to the source RNC the PLMN List Response message including the PLMN list with the PLMN ids broadcasted from the current cell of the UE.

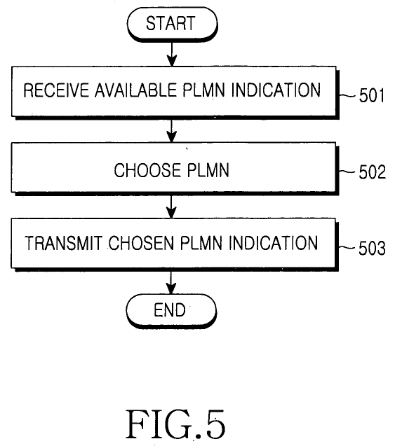

FIG. 5 is a flowchart illustrating an operation of the UE according to an exemplary embodiment of the present invention.

Referring to FIG. 5, upon receipt of an Available PLMN Indication message including PLMN ids broadcasted from the target cell from the source RNC in step 501, the UE selects one appropriate PLMN id among the PLMN ids in step 502. The PLMN selection takes place at the AS or NAS layer of the UE. For example, the UE selects the PLMN id of a CN operator with the highest priority level, according to predetermined priority levels of CN operators. A selection process of an appropriate PLMN id will be omitted from the exemplary embodiments of the present invention for clarity and conciseness. In step 503, the UE transmits a Chosen PLMN Indication message with the selected PLMN id to the source RNC.

In accordance with the exemplary embodiments of the present invention as described above, prior to the SRNC relocation, the source RNC provides the UE with a PLMN list listing CN operators available in the target RNC in order to select the CN operator appropriate for the UE after the SRNC relocation. Therefore, the UE can connect to the best CN operator via the target cell even after the SRNC relocation.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method in a source radio network controller (RNC) for relocating a serving radio network controller (SRNC) in a radio access network (RAN) that controls radio resources for a user equipment (UE) in a network sharing (NS) system where the RAN is shared among a plurality of core network (CN) operators, the method comprising the steps of:
requesting to a target RNC a CN operator identifier (ID) list with IDs of CN operators sharing the target RNC, if a SRNC relocation from the source RNC to the target RNC is determined;
receiving the CN operator ID list from the target RNC;
providing the CN operator ID list to the UE; and
receiving from the UE a CN operator ID selected from the CN operator ID list, selecting a CN operator corresponding to the selected CN operator ID, and performing a SRNC relocation.

2. The method of claim 1, wherein the CN operator IDs comprises Public Land Mobile Network (PLMN) IDs.

3. The method of claim 1, wherein the step of requesting a CN operator ID comprises the step of transmitting a list request message including an ID of the UE to the target RNC.

4. The method of claim 1, wherein the step of receiving the CN operator ID list comprises the step of receiving from the target RNC a list response message including the ID of the UE and the CN operator ID list with CN operator IDs broadcasted from a target cell of the UE.

5. The method of claim 1, wherein the step of providing the CN operator ID list comprises the step of transmitting an available ID indication message with the CN operator ID list on a dedicated control channel to the UE.

6. The method of claim 1, wherein the step of receiving the CN operator ID comprises the step of receiving a selected ID indication message comprising the selected CN operator ID on a dedicated control channel from the UE.

7. A method in a user equipment (UE) for relocating a serving radio network controller (SRNC) in a radio access network (RAN) that controls radio resources for the UE in a network sharing (NS) system where the RAN is shared among a plurality of core network (CN) operators, comprising the steps of:
receiving from a source RNC a CN operator identifier (ID) list with IDs of CN operators sharing a target RNC, if a SRNC relocation from the source RNC to the target RNC is determined;
selecting a designated CN operator ID among the CN operators IDs; and
transmitting the selected CN operator ID to the source RNC.

8. The method of claim 7, wherein the CN operator IDs comprises Public Land Mobile Network (PLMN) IDs.

9. The method of claim 7, wherein the step of receiving the CN operator ID comprises the step of receiving an available ID indication message with the CN operator ID list on a dedicated control channel from the source RNC.

10. The method of claim 7, wherein the step of transmitting the selected CN operator ID comprises the step of transmitting a selected ID indication message including the selected CN operator ID on a dedicated control channel to the source RNC.

11. A system for relocating a serving radio network controller (SRNC) in a radio access network (RAN) in a network sharing (NS) system where the RAN is shared among a plurality of core network (CN) operators, the system comprising:
a user equipment (UE) for selecting an intended CN operator identifier (ID) among CN operator IDs of a CN operator list; and
a source RNC for requesting to a target RNC the CN operator identifier (ID) list with IDs of CN operators sharing the target RNC, if a SRNC relocation from the source RNC to the target RNC is determined for the UE, receiving the CN operator ID list from the target RNC, and providing the CN operator ID list to the UE, wherein the UE transmits the selected CN operator ID to the source RNC, and the source RNC receives the selected CN operator ID from the UE and performs the SRNC relocation by selecting a CN operator corresponding to the selected CN operator ID.

12. The system of claim 11, wherein the CN operator IDs comprises Public Land Mobile Network (PLMN) IDs.

13. The system of claim 11, wherein the source RNC transmits a list request message comprising an ID of the UE to the target RNC.

14. The system of claim 11, wherein the source RNC receives a list response message comprising the ID of the UE and the CN operator ID list with CN operator IDs broadcasted from a target cell of the UE from the target RNC.

15. The system of claim 11, wherein the source RNC transmits an available ID indication message with the CN operator ID list on a dedicated control channel to the UE.

16. The system of claim 11, wherein the source RNC receives a selected ID indication message comprising the selected CN operator ID on a dedicated control channel from the UE.
